(19) United States
(12) Patent Application Publication
(10) Pub. No.: US 2025/0004204 A1
(43) Pub. Date: Jan. 2, 2025

(54) SYSTEM FOR COUPLING A MULTI-CORE OPTICAL FIBER WITH AT LEAST ONE SINGLE-CORE OPTICAL FIBER, AND CORRESPONDING COUPLING METHOD

(71) Applicant: Orange, Issy-les-Moulineaux (FR)

(72) Inventor: Philippe CHANCLOU, CHATILLON CEDEX (FR)

(21) Appl. No.: 18/759,441

(22) Filed: Jun. 28, 2024

(30) Foreign Application Priority Data
Jun. 30, 2023 (FR) 2306988

(51) Int. Cl. G02B 6/26; G02B 6/02; G02B 6/32

(52) U.S. Cl. CPC G02B 6/262; G02B 6/02042; G02B 6/32

(57) ABSTRACT

The disclosed technology relates to a coupling system between a multi-core optical fiber (MCF) and a set of at least one single-core optical fiber (SCF), each single-core fiber of the set being coupled with a separate core of the multi-core fiber, the coupling system comprising: a gradient-index lens (GRIN-L), positioned between the multi-core fiber and the at least one single-core fiber; a first gradient-index fiber section coupled at the end of the multi-core fiber to form a first microlensed end (GRIN-MCF); for each single-core fiber of said set, a second gradient-index fiber section coupled at the end of the single-core fiber to form a second microlensed end (GRIN-SCF); the first and second microlensed ends being coupled on either side of the lens with a radial offset of one relative to the other defined according to a core parameter of the multi-core fiber.

### CROSS-REFERENCE TO RELATED APPLICATIONS

This application claims foreign priority to French Application No. 2306988, filed Jun. 30, 2023, the entire contents of which are incorporated by reference herein in its entirety and for all purposes.

### BACKGROUND

### Field

The disclosed technology relates to the field of optical data transmission, and more particularly that of the interconnection between a multi-core optical fiber and at least one single-core optical fiber.

### Description of the Related Technology

Telecommunications networks require large transmission capacities. Thus, multi-core optical fibers may be preferred to single-core optical fibers, because they allow simultaneous transmission of several optical signals in a more compact manner. Interconnection solutions between multi-core fibers and single-core fibers are therefore used to transfer optical signals from one to the other and the other way around.

Thus, there are numerous interconnection methods. For example, the article “Compact Multi-core Fiber Fan-in/out Using GRIN Lens and Microlens Array”, Arao H. et al., 2014, OECC/ACOFT, hereinafter referenced “Arao”, proposes an interconnection method between a multi-core optical fiber and a single-core optical fiber array. Thus, in the Arao article, a discrete microlens array is used after a gradient-index lens and a glass spacer, in order to redirect the optical beams from the multi-core fiber, to the mono-core optical fiber array. However, the use of a glass spacer in order to increase the spacing of the beams, is not a very compact solution. Furthermore, the use of microlenses involves problems of alignment, lack of compactness, and therefore difficulties implementing the system.

Consequently, it is necessary to provide a compact and easy-to-implement solution, making it possible in particular to facilitate the alignment of the different elements of the system.

### SUMMARY OF CERTAIN INVENTIVE ASPECTS

The disclosed technology addresses this need by providing a coupling system between a multi-core optical fiber and a set of at least one single-core optical fiber, each single-core fiber of said set being coupled with a separate core of the multi-core fiber, said coupling system comprising:
a gradient-index lens, positioned between said multi-core fiber and said at least one single-core fiber;
a first gradient-index fiber section coupled at the end of the multi-core fiber to form a first microlensed end;
for each single-core fiber of said set, a second gradient-index fiber section coupled at the end of the multi-core fiber to form a second microlensed end;
said first and second microlensed ends being coupled on either side of said lens with a radial offset of one relative to the other defined according to a core parameter of the multi-core fiber.

Thus, such a coupling system makes it possible to facilitate the alignment of the different elements. In particular, the use of gradient-index fiber sections having a similar diameter to the diameter of the multi/single-core fibers allows definitive attachment by welding of the gradient-index fibers to the ends of the multi/single-core fibers. The alignment of the elements of such a system is therefore easier than with a microlens array as described in other approaches.

Furthermore, such a coupling system is compact because it does not require the use of a glass spacer, or of a microlens array. Indeed, the gradient-index fiber sections make it possible to gain in compactness by acting both as lens/collimator, enabling precise control of the angle and the diameter of each of the beams in order to guide them correctly from one optical fiber to the other.

According to a particular feature of the disclosed technology, the radial offset of each single-core fiber is defined by a distance h, the distance h being defined as follows:

$$h = e \times \frac{{n}_{1} \times {g}_{1}}{{n}_{2} \times {g}_{2}}$$

with the following optical parameters:
e said core parameter, defined as being the radial distance between the central axis of the multi-core fiber and the axis of the core of the multi-core fiber with which said single-core fiber is coupled;
n₁ the refractive index at the center of said first gradient-index fiber section;
g₁ the quadratic coefficient of said first gradient-index fiber section;
n₂ the refractive index at the center of said gradient-index lens;
g₂ the quadratic coefficient of said gradient-index lens.

Thus, the distribution of the single-core fibers, and therefore the distance between them is optimized in order to obtain a compact coupling system. Furthermore, the distance h must be greater than a threshold value selected according to the diameter of the single-core fibers.

According to a particular feature of the disclosed technology, the length l₁ of the first gradient-index fiber section of said multi-core fiber is inversely proportional to its quadratic coefficient g₁; the length l₂ of the gradient-index lens is inversely proportional to its quadratic coefficient g₂; and the length l₃ of the gradient-index fiber section of said at least one single-core fiber, is inversely proportional to its quadratic coefficient g₃.

Thus, the length of the gradient-index fiber sections is adapted in order to correctly transmit the optical beams from one optical fiber to another. These gradient-index fiber sections have a similar role to that of a lens/collimator, and make it possible to direct and control the beams to guide them correctly from one optical fiber to another.

According to an embodiment of the disclosed technology, the cores of the multi-core optical fiber and the set of at least one single-core optical fiber are of single-mode type.

Thus, the coupling system may be used in the context of signal transmission over long distances. Indeed, single-mode optical fibers make it possible to limit noise and losses, and are therefore preferably used over long distances.

According to another embodiment, the cores of the multi-core optical fiber and the set of at least one single-core optical fiber are of multi-mode type, and transmit spatially multiplexed signals.

Thus, the coupling system may be used in the context of simultaneous transmission of several optical signals, often over shorter distances than for single-mode fibers. Indeed, multi-mode optical fibers transmit spatially multiplexed signals composed of a plurality of signals, reflected along different angles to form a plurality of modes (modal multiplexing). The transmitted data speed is therefore increased.

According to another embodiment, the cores of the multi-core optical fiber and the set of at least one single-core optical fiber support WDM (Wavelength Division Multiplexing) type transmissions, and therefore transmit wavelength multiplexed signals.

Thus, the coupling system may be used in the context of simultaneous transmission of several optical signals, often over shorter distances than for single-mode fibers. Indeed, like multi-mode type fibers, WDM transmissions make it possible to increase the data transmission speed on an optical fiber, compared to a single-mode optical fiber only comprising a single-mode optical fiber only comprising a single signal, because wavelength multiplexed signals are composed of a plurality of signals each having a separate wavelength.

Alternatively, the coupling system comprises at least two different types of single-core fibers and multi-core fiber cores from the single-mode type, multi-mode type and type supporting WDM transmission, i.e. a compatible coupling for all of the wavelengths from 1260 nm to 1675 nm.

Thus, the coupling system may use single-core fibers and multi-core fibers of different types. For example, a multi-core fiber may include a single-mode type code and a multi-mode type core, each of the cores being respectively associated with a single-mode fiber and a multi-mode fiber within the coupling system.

According to a particular embodiment, said first and second microlensed ends are coupled directly at the input and output of said gradient-index lens.

Thus, the coupling system is simple and compact, with easier implementation, in particular such a system makes it possible to facilitate the alignment of the different elements composing it.

According to another particular embodiment, at least one of said first and second microlensed ends is coupled at the input and output of said gradient-index lens via an optical component belonging to the group comprising:
an optical strip;
an optical filter;
an anti-glare component;
an optical isolator.

Thus, the system may have additional elements, making it possible to obtain a more elaborate system with additional optical functions, the system remaining compact and easy to implement.

According to an alternative of the disclosed technology, the end of the multi-core fiber and the first corresponding microlensed end are comprised in an independent ferrule; each end of single-core fiber of said set and the second corresponding microlensed end are comprised in an independent ferrule; and the gradient-index lens is independent.

According to another alternative of the disclosed technology, the end of the multi-core fiber, the first corresponding microlensed end and the gradient-index lens are comprised in a same ferrule, on one hand; and each single-core fiber end of said set and the second corresponding microlensed end are comprised in an independent ferrule, on the other.

According to another alternative of the disclosed technology, the end of the multi-core fiber and the first corresponding micro-lensed end are comprised in a first independent ferrule, on one hand; and the set of at least one single-core fiber end, each second corresponding microlensed end, and the gradient-index lens are comprised in a second ferrule, on the other.

Thus, different coupling modes may be used for the implementation of the coupling system. Different element blocks may thus be interconnected via independent ferrules, these ferrules forming separate element blocks (independent blocks) and allowing removable mechanical assembly between these different blocks. The term “independent” specifies the separate nature of the different element blocks, as well as the removable nature of any connection between these blocks.

The disclosed technology also relates to a method for coupling a multi-code optical fiber and a set of at least one single-core optical fiber, said method comprising:
welding a first gradient-index fiber section at the end of said multi-core fiber to form a first microlensed end;
for each single-core fiber of said set, welding a second gradient-index fiber section at the end of said single-core fiber to form a second microlensed end;
mechanically assembling said first microlensed end of said multi-core fiber with a first interface of a gradient-index lens;
mechanically assembling said second micro-lensed end of said single-core fiber with a second interface of said gradient-index lens, with a radial offset relative to the first microlensed end, defined according to a core parameter of the multi-core fiber.

Thus, such a coupling method allows a simple assembly of the system where the alignment of the different elements is facilitated. In particular, the use of gradient-index fiber sections having a similar diameter to the diameter of the multi/single-core fibers allows definitive attachment by welding. The system thus obtained and compact and easy to implement.

### BRIEF DESCRIPTION OF THE DRAWINGS

Other aims, features and advantages of the technique will appear upon reading the following description, given as a merely illustrative and non-limiting example, and which refers to the appended figures, wherein:

FIG. 1 represents a coupling system according to an example embodiment of the disclosed technology.

FIG. 2 represents a coupling system according to another example embodiment of the disclosed technology.

FIG. 3 represents a cross-section and a longitudinal section of a multi-core optical fiber according to an example embodiment.

FIG. 4 represents a cross-section and a longitudinal section of a single-core optical fiber according to an example embodiment.

FIG. 5 represents the coupling of a multi-core optical fiber with a gradient-index fiber section, according to an example embodiment.

FIG. 6 represents the coupling of a single-core optical fiber with a gradient-index fiber section, according to an example embodiment.

FIG. 7 represents the coupling of a multi-core optical fiber and a gradient-index fiber section with a gradient-index lens, according to an example embodiment.

FIG. 8 is a diagram representing the steps of the coupling method according to an embodiment of the disclosed technology.

FIG. 9 represents a cross-section and a longitudinal section of a multi-core optical fiber according to a first particular example embodiment, wherein the multi-core optical fiber comprises 4 cores.

FIG. 10 represents the coupling of a multi-core optical fiber with a gradient-index fiber section, according to the first particular example embodiment.

FIG. 11 represents the refractive index profiles of the different elements of the coupling system according to the distance relative to the center of each element, according to the first particular example embodiment.

FIG. 12 represents a coupling system, according to the first particular example embodiment.

FIG. 13 represents a cross-section and a longitudinal section of a multi-core optical fiber according to a second particular example embodiment, wherein the multi-core optical fiber comprises five cores, including a central core.

FIG. 14 represents the coupling of a multi-core optical fiber with a gradient-index fiber section, according to the second particular example embodiment.

FIG. 15 represents a coupling system, according to the second particular example embodiment.

FIG. 16 represents a coupling system comprising additional optical functions, according to an example embodiment.

FIG. 17 represents a coupling system comprising different interconnected blocks, according to a first example embodiment.

FIG. 18 represents a coupling system comprising different interconnected blocks, according to a second example embodiment.

FIG. 19 represents a coupling system comprising different interconnected blocks, according to a third example embodiment.

### DETAILED DESCRIPTION OF CERTAIN ILLUSTRATIVE EMBODIMENTS

### 1. General Principle

The disclosed technology relates to a compact and easy-to-implement coupling technique, between a multi-core optical fiber and at least one single-core optical fiber.

More particularly, as illustrated by FIG. 1, the coupling technique according to the disclosed technology uses multi-core (MCF) and single-core fibers (SCF), each of these optical fibers having a gradient-index section at its end, forming a microlensed end (GRIN-MCF, GRIN-SCF). Furthermore, a gradient-index lens (GRIN-L) is inserted between the microlensed end of the multi-core fiber, on one hand, and the microlensed ends of the single-core fibers, on the other.

The multi-core and single-core fibers used according to the technique of the disclosed technology may be multi-mode and/or single-mode type and/or capable of supporting WDM type transmission. In the case of single-mode fibers, optical beam propagation within multi-core and single-core fibers may be performed according to an axial mode (zero angle of incidence at the fiber core input).

According to a first embodiment, the coupling system may be used to transmit optical beams from at least one single-core optical fiber to the cores of a multi-core optical fiber.

According to a second embodiment, the coupling system may be used to transmit optical beams from the cores of a multi-core optical fiber to at least one single-core optical fiber. This second embodiment is used to support the description hereinafter, it being understood that the technique according to the disclosed technology is not limited thereto.

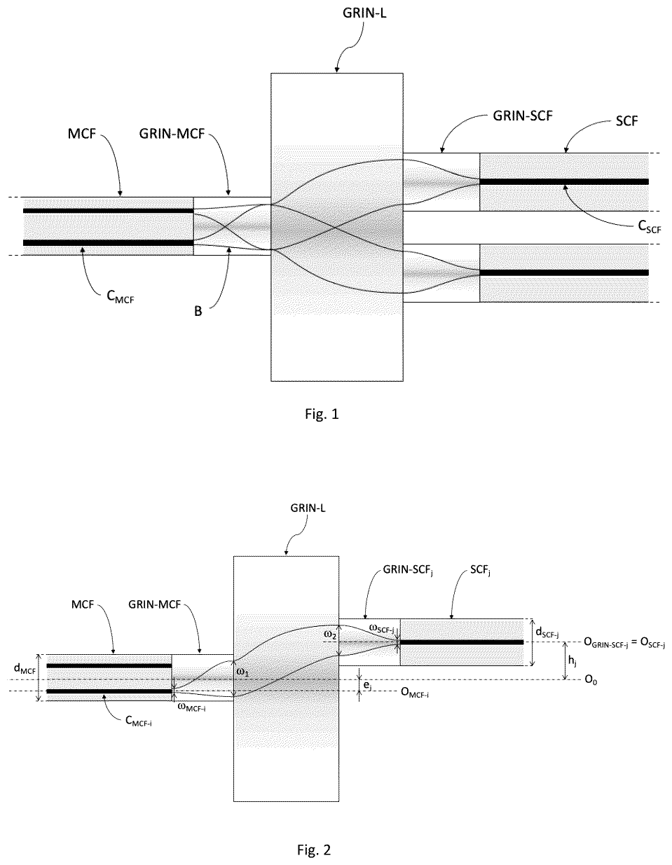

Thus, the coupling system according to the disclosed technology uses a multi-core optical fiber comprising n cores, n being a natural integer greater than or equal to 2, on one hand; and m single-core optical fibers, m being a natural integer greater than or equal to 1, and less than or equal to n, on the other. Thus, with reference to FIG. 2, the optical beam at the input of the single-core optical fiber j (SCFⱼ) is from the core i (C_{MCF-i}) of said multi-core optical fiber, where i=j and iϵ{1, . . . , n} and jϵ{1, . . . , m}.

According to a particularly advantageous embodiment, a single-core fiber corresponds to each core of the multi-core fiber, i.e. n=m.

### 1.1. Multi-Core Optical Fiber (MCF)

On one hand, the coupling system according to the disclosed technology therefore uses a multi-core optical fiber. This multi-core optical fiber comprises at least two cores. As mentioned above, the cores of the multi-core fiber may be single-mode and/or multi-mode and/or capable of supporting WDM type transmission.

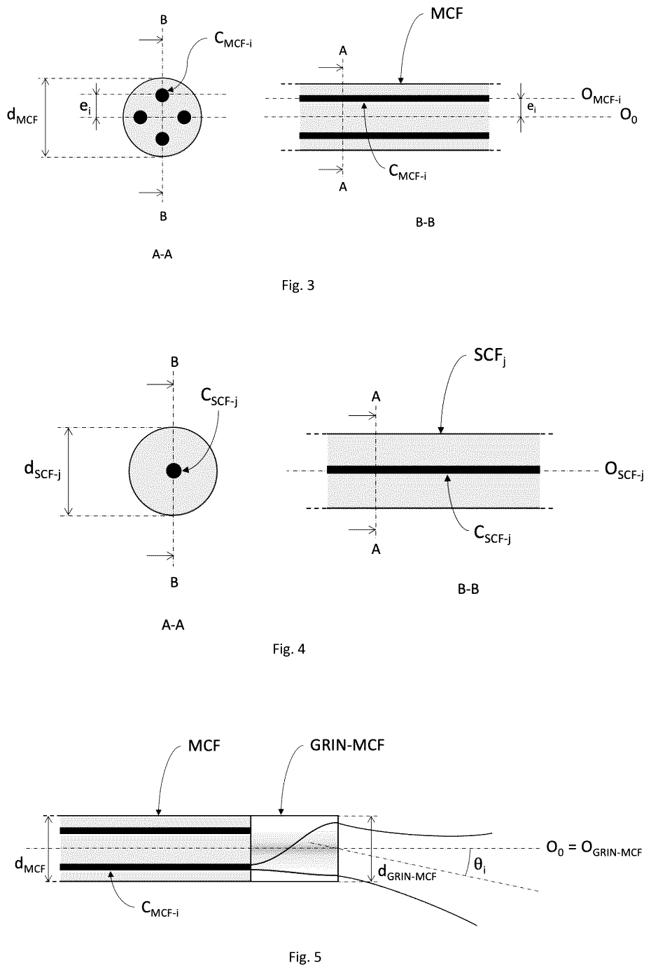

As illustrated by FIG. 2 and FIG. 3, the multi-core fiber (MCF) has a diameter d_{MCF}. This diameter d_{MCF} is typically between 80 and 225 μm, for example 125 μm. The diameter of the optical beam inside the core C_{MCF-i} of the multi-core fiber is ω_{MCF-i}. Finally, a distance eᵢ can be defined between the center of the multi-core fiber (corresponding to an axis O₀), and the center of the core C_{MCF-i} of the multi-core fiber (corresponding to an axis O_{MCF-i}).

The axis O₀ corresponding to the center of the multi-core optical fiber defines the main optical axis of the system. The axis O_{MCF-i} is therefore parallel with the main axis of the system, and spaced by a distance eᵢ relative to this main axis.

The coupling system according to the disclosed technology makes it possible to transmit the optical beam from the core C_{MCF-i} of the multi-core optical fiber to the core of the single-core optical fiber SCF-j, it being understood that the beam may also be transmitted in the opposite direction.

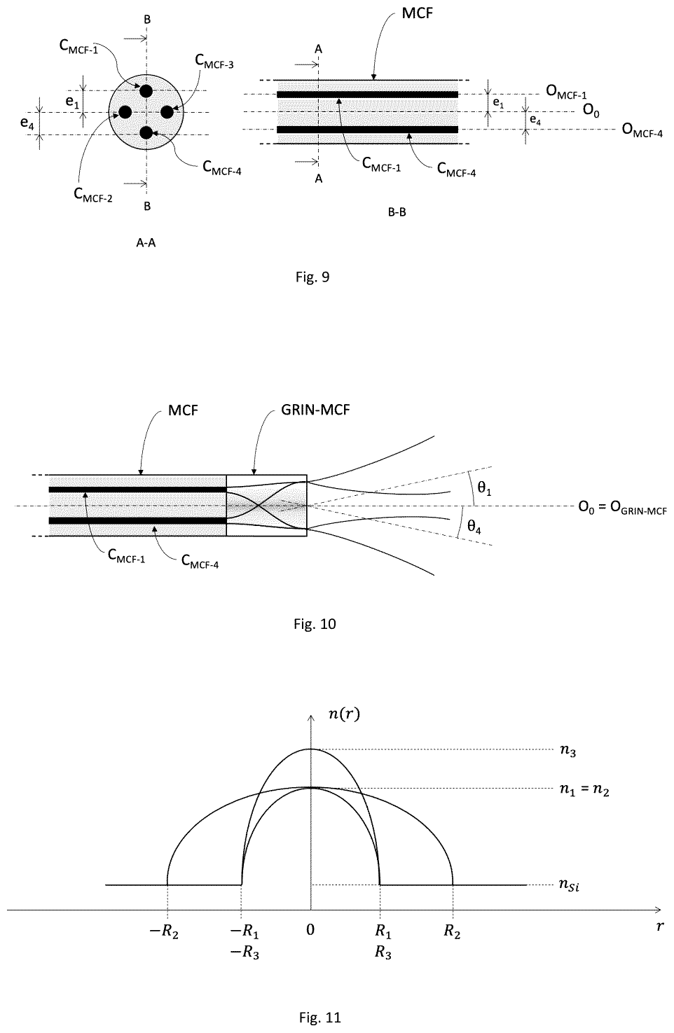

According to a first example embodiment illustrated by FIG. 9, the multi-core optical fiber (MCF) may comprise 4 cores (C_{MCF-1}, C_{MCF-2}, C_{MCF-3}, C_{MCF-4}). According to this example, the center of each of these cores is spaced by a distance eᵢ (e₁, e₄) relative to the main axis of the system (O₀). More specifically, FIG. 9 represents, on one hand, a cross-section (A-A) of a multi-core optical fiber, with a uniform distribution of the 4 cores about the main optical axis of the system (O₀); and, on the other, FIG. 9 represents a longitudinal section (B-B) of this optical fiber, passing through the main optical axis of the system, at the cores C_{MCF-1}, and C_{MCF-4}. The plane of this longitudinal section B-B therefore comprises the axes O₀, O_{MCF-1} and O_{MCF-4}.

According to a second example embodiment illustrated by FIG. 13, the multi-core optical fiber (MCF) may comprise a central core. More particularly, according to FIG. 13, the multi-core optical fiber may comprise five cores (C_{MCF-1}, C_{MCF-2}, C_{MCF-3}, C_{MCF-4}, C_{MCF-5}). According to this example, the center of each of these cores is spaced by a distance eᵢ (e₁, e₄) relative to the main axis of the system (O₀), with a zero distance for the core C_{MCF-5}. The core C_{MCF-5} is therefore positioned at the center of the multi-core fiber. More specifically, FIG. 13 represents, on one hand, a cross-section (A-A) of a multi-core optical fiber, with a uniform distribution of four cores about the main optical axis of the system (O₀) and a central core; and, on the other, FIG. 13 represents a longitudinal section (B-B) of this optical fiber, passing through the main optical axis of the system, at the cores C_{MCF-1}, C_{MCF-4} and C_{MCF-5}. The plane of this longitudinal section B-B therefore comprises the axes O₀, O_{MCF-1}, O_{MCF-4} and O_{MCF-5}, with the axes O₀ and O_{MCF-5} merged.

### 1.2. Single-Core Optical Fiber (SCF)

Furthermore, the coupling system uses at least one single-core optical fiber. As mentioned above, the core of the single-core fiber may be single-mode, multi-mode or capable of supporting WDM type transmission.

As illustrated by FIG. 2 and FIG. 4, the single-core fiber (SCFⱼ) has a diameter d_{SCF-j}. This diameter d_{SCF-j} is typically between 80 and 225 μm, more particularly between 80 and 125 μm, for example 125 μm. The single-core fiber comprises a core C_{SCF-j}. The diameter of the optical beam inside the core is ω_{SCF-j}. Finally, the single-core fibers may have a radial offset relative to the multi-core optical fiber, according to a core parameter of the multi-core optical fiber. More particularly, this radial offset may be defined according to eᵢ, by a distance hⱼ defined between the center of the single-core fiber (corresponding to an axis O_{SCF-j}), and the main optical axis of the system. The axis O_{SCF-i} is therefore parallel with the main axis of the system, and spaced by a distance hⱼ relative to this main axis. More specifically, this distance hⱼ may be defined by the following formula:

$${h}_{j} = {e}_{i} \times \frac{{n}_{1} \times {g}_{1}}{{n}_{2} \times {g}_{2}}$$

where
n₁ is the refractive index at the center of the gradient-index fiber segment coupled with the multi-core fiber; and
g₁ is the quadratic coefficient of the gradient-index fiber segment coupled with the multi-core fiber;
n₂ is the refractive index at the center of the gradient-index lens; and
g₂ is the quadratic coefficient of the gradient-index lens.

This distance h; makes it possible to optimize the placement of the single-core optical fibers, thus making it possible to obtain a compact coupling system. Furthermore, this distance is selected so as be greater than a threshold value predefined according to the diameter of the single-core fibers.

### 1.3. Gradient-Index Fiber Section (GRIN-MCF) at the End of the Multi-Core Fiber

As illustrated by FIG. 5, the end of the multi-core optical fiber (MCF) is coupled with a gradient-index fiber section of cylindrical shape, making it possible to obtain a first microlensed end (GRIN-MCF). Thus, this gradient-index fiber section has a lensing and collimation function in order to control the radius and angle of the optical beam transmitted.

The diameter of the gradient-index fiber section is d_{GRIN-MCF}. This diameter d_{GRIN-MCF} may be between 80 and 400 μm, and more particularly between 80 and 250 μm. According to an example embodiment, the diameter d_{GRIN-MCF} is advantageously similar to the diameter of the multi-core fiber d_{MCF}. However, a tolerance of a few hundred micrometers may be applied between d_{GRIN-MCF} and d_{MCF}. Indeed, it is possible to weld (assemble) fibers of different diameters with a tolerance of the order of a few 100 μm. More particularly, the following tolerance may be applied: d_{GRIN-MCF}=d_{MCF}±200 μm. For example, a multi-core optical fiber, having a diameter d_{MCF} equal to 125 μm, may be coupled with a gradient-index fiber section having a diameter d_{GRIN-MCF} equal to 250 μm. Or according to another example, illustrated by the examples of FIG. 10 and FIG. 14, a multi-core optical fiber, having a diameter d_{MCF} equal to 125 μm, may be coupled with a gradient-index fiber section having a diameter d_{GRIN-MCF} equal to 125 μm.

This coupling may thus be performed for welding on account of the dimensional similarity of the diameters of these two elements.

Furthermore, the gradient-index fiber section has a central axis O_{GRIN-MCF}. According to a particular embodiment, this axis O_{GRIN-MCF} is aligned with the main optical axis of the system O₀, with a tolerance of <±1 μm. Thus, according to a particular example embodiment illustrated by FIG. 5, this central axis O_{GRIN-MCF} is merged with the main axis of the system O₀.

The gradient-index fiber section (GRIN-MCF) may be composed of organic or mineral glass. The material used may be doped to obtain a specific refractive index profile. According to an example embodiment, this profile declines from the center of the section toward its circumference. Thus, the refractive index at the center of the gradient-index fiber section is n₁. According to an example embodiment wherein the section is made of pure silica, this index n₁ is greater than the refractive index of the silica nₛᵢ, where nₛᵢ=1.457 to 632.8 nm (for an HeNe laser). In this case, the refractive index profile may be obtained by doping silica with one or more elements making it possible to increase or decrease the refractive index of silica (Ge, P, Al, Cl, Ti, Br, B, F).

The quadratic coefficient of the gradient-index section is g₁. This quadratic coefficient g₁ has values typically between 0.5 and 10 mm⁻¹.

The length of the gradient-index section is l₁. This length l₁ is between 100 μm and 10 mm, for example equal to 500 μm. This length l₁ is defined according to the quadratic coefficient of the section g₁. More particularly, this length is defined by the formula:

$${l}_{1} = \frac{π}{2 \times {g}_{1}}$$

As illustrated by FIG. 2, the diameter of the optical beam at the interface between the gradient-index fiber section of the multi-core optical fiber and the gradient-index lens is ω₁. This diameter ω₁ may be defined by the following formula (where λ is the wavelength of the beam transmitted):

$${ω}_{1} = \frac{λ}{π \times {n}_{1} \times {g}_{1} \times {ω}_{0}}$$

As illustrated by FIG. 5, the angle of the optical beam, from (or toward) the core C_{MCF-i}, at the output (or at the input) of the gradient-index fiber section is θᵢ. This angle may be defined by the following formula:

$${θ}_{i} = {e}_{i} \times {g}_{i}$$

Thus, the gradient-index section makes it possible to replace the microlens assemblies of other approaches. This section has a lensing and collimation function in order to direct and control the optical beam transmitted. All of the parameters mentioned above are co-dependent and may be adapted to obtain the desired dimensions and orientations, and thus optimize the transmission of the optical beam. Furthermore, on account of the dimensions of this gradient-index fiber section, it may be welded directly to the multi-core optical fiber. Welding thus making it possible to definitively set a specific alignment of the elements. Therefore, this makes it possible to limit alignment errors and facilitate the use of the coupling system, while obtaining a compact assembly.

### 1.4. Gradient-Index Fiber Section (GRIN-SCF) at the End of Each Single-Core Fiber

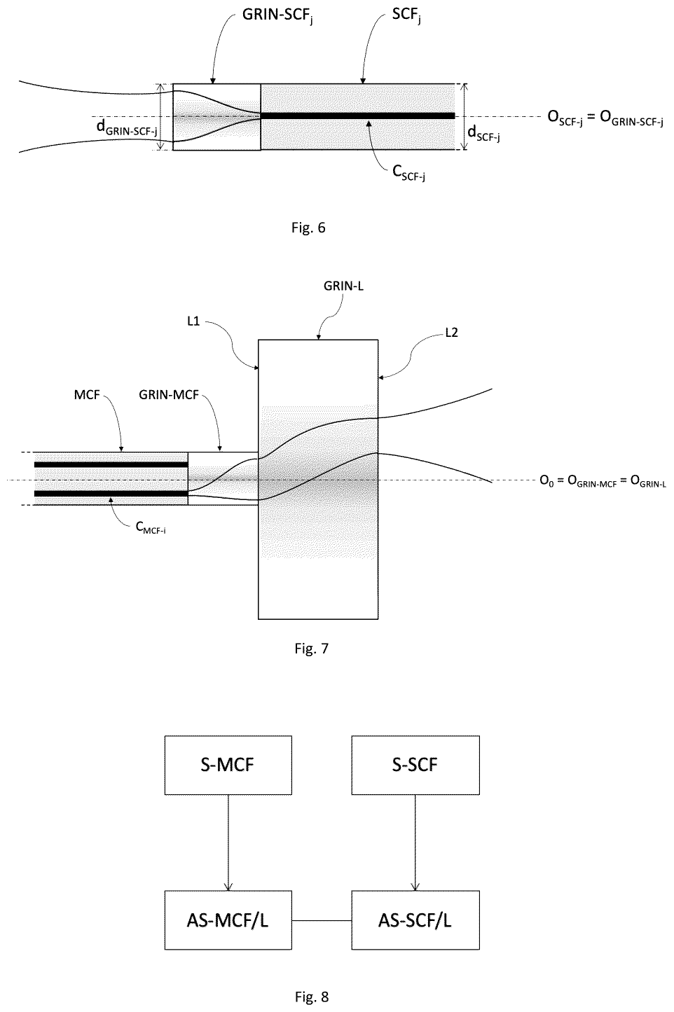

As illustrated by FIG. 6, the end of a single-core optical fiber (SCFⱼ) is coupled with a gradient-index fiber section of cylindrical shape, making it possible to obtain a second microlensed end (GRIN-SCFⱼ). Thus, this gradient-index fiber section has a lensing and collimation function in order to control the radius and angle of the optical beam transmitted.

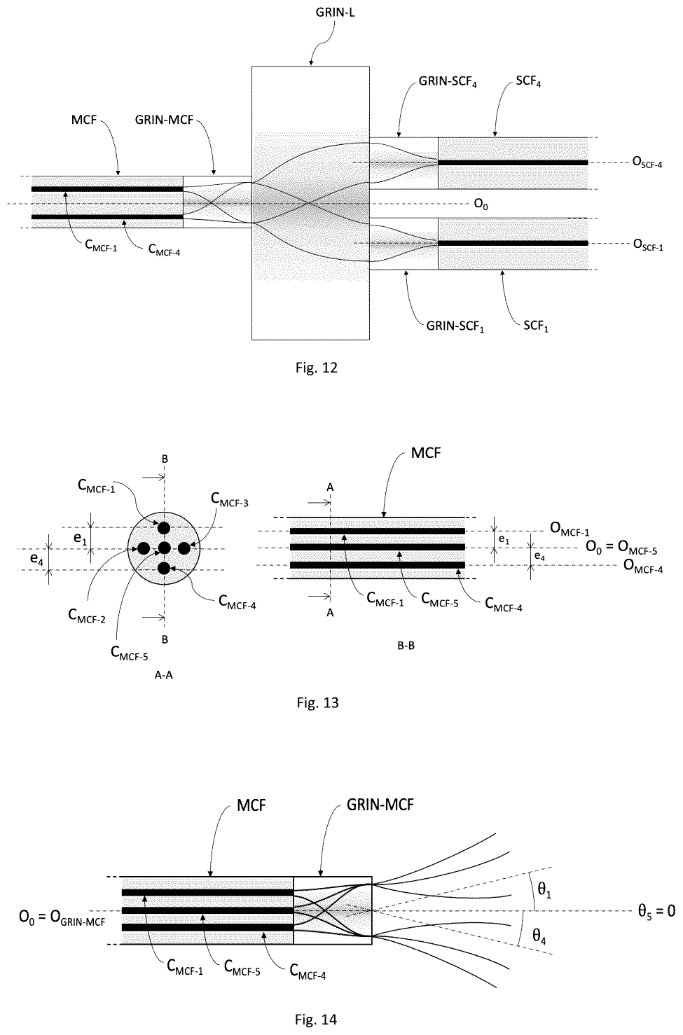

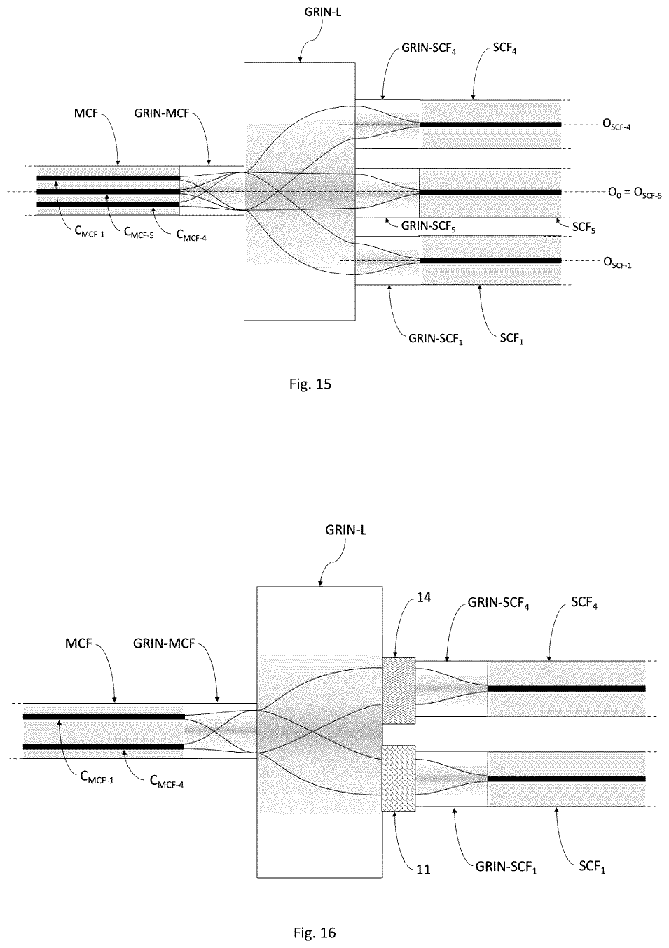

The diameter of the gradient-index fiber section is d_{GRIN-SCF-j}. This diameter d_{GRIN-SCF-j} may be between 80 and 400 μm, and more particularly between 80 and 250 μm. According to an example embodiment, the diameter d_{GRIN-SCF-j} is advantageously similar to the diameter of the single-core fiber d_{SCF-j}. However, a tolerance of a few hundred micrometers may be applied between d_{GRIN-SCF-j} and d_{SCF-j}. Indeed, it is possible to weld/assemble fibers of different diameters with a tolerance of the order of a few 100 μm. More particularly, the following tolerance may be applied: d_{GRIN-SCF-j}=d_{SCF-j}±200 μm. For example, a multi-core optical fiber, having a diameter d_{SCF-j} equal to 125 μm, may be coupled with a gradient-index fiber section having a diameter d_{GRIN-SCF-j} equal to 250 μm. Or according to another example, illustrated by the examples of FIG. 12 and FIG. 15, a multi-core optical fiber, having a diameter d_{SCF-j} equal to 125 μm, may be coupled with a gradient-index fiber section having a diameter d_{GRIN-SCF-j} equal to 125 μm.

This coupling may thus be performed for welding on account of the dimensional similarity of the diameters of these two elements.

Furthermore, the gradient-index fiber section has a central axis O_{GRIN-SCF-j}. According to a particular embodiment, this axis O_{GRIN-SCF-j} is aligned with the axis of the single-core fiber O_{SCF-j}, with a tolerance of <±1 μm. Thus, according to a particular example embodiment illustrated by FIG. 6, this central axis O_{GRIN-SCF-j} is merged with the axis of the single-code fiber O_{SCF-j}.

The gradient-index fiber section (GRIN-SCFⱼ) may be composed of organic or mineral glass. The material used may be doped to obtain a specific refractive index profile. According to an example embodiment, this profile declines from the center of the section toward its circumference. Thus, the refractive index at the center of the gradient-index fiber section is n₃₋ⱼ. According to an example embodiment wherein the section is made of pure silica, this index n₃₋ⱼ is greater than the refractive index of the silica nₛᵢ, where nₛᵢ=1.457 to 632.8 nm (for an HeNe laser). In this case, the refractive index profile may be obtained by doping silica with one or more elements making it possible to increase or decrease the refractive index of silica (Ge, P, Al, Cl, Ti, Br, B, F).

The quadratic coefficient of the gradient-index section is g₃₋ⱼ. This quadratic coefficient g₃ has values typically between 0.5 and 10 mm⁻¹.

The length of the gradient-index fiber section (GRIN-SCFⱼ) is l₃₋ⱼ. This length l₃₋ⱼ is between 100 μm and 10 mm, for example equal to 500 μm. This length l₃₋ⱼ is defined according to the quadratic coefficient of the section g₃₋ⱼ. More particularly, this length is defined by the formula:

$${l}_{3 - j} = \frac{π}{2 \times {g}_{3 - j}}$$

As illustrated by FIG. 2, the diameter of the optical beam at the interface between the gradient-index fiber section of the multi-core optical fiber and the gradient-index lens is ω₂. This diameter ω₂ may be defined by the following formula (where λ is the wavelength of the beam transmitted):

$${ω}_{2} = \frac{λ}{π \times {n}_{2} \times {g}_{2} \times {ω}_{1}}$$

where ω₂ is the diameter of the beam at the interface between the gradient-index fiber section GRIN-SCFj and the gradient-index lens (GRIN-L).

According to the example illustrated by FIG. 6, the angle of the optical beam, from (or toward) the single-core fiber SCFⱼ, at the output (or at the input) of the gradient-index fiber section is zero.

As mentioned above relative to the single-core optical fiber, the gradient-index fiber section associated with a single-core fiber has a radial offset relative to the multi-core optical fiber and the associated gradient-index fiber section, according to a core parameter of the multi-core fiber. More particularly, this radial offset may be defined by the distance hⱼ between the center of the single-core fiber and/or the center of the associated gradient-index section (corresponding respectively to an axis O_{SCF-j} and/or an O_{GRIN-SCF-j}), on one hand, and the main optical axis of the system O₀, on the other.

Thus, the gradient-index section makes it possible to replace the microlens assemblies of other approaches. This section has a lensing and collimation function in order to direct and control the optical beam transmitted. All of the parameters mentioned above are co-dependent and may be adapted to obtain the desired dimensions and orientations, and thus optimize the transmission of the optical beam. Furthermore, on account of the dimensions of this gradient-index fiber section, it may be welded directly to the multi-core optical fiber. Welding thus making it possible to definitively set a specific alignment of the elements. Therefore, this makes it possible to limit alignment errors and facilitate the implementation of the coupling system, while obtaining an extremely compact assembly.

### 1.5. Gradient-Index Lens (GRIN-L)

As illustrated by FIG. 7, the gradient-index fiber section (GRIN-MCF) previously coupled, on one hand, with the multi-core fiber (MCF) is coupled, on the other, with the gradient-index lens (GRIN-L). More particularly, but not exclusively, the gradient-index lens has an overall cylindrical shape and has two connection interfaces (L1, L2). A first interface (L1) is therefore coupled with the gradient-index fiber section of the multi-core fiber (GRIN-MCF), whereas a second interface (L2) is intended to be coupled with the gradient-index sections of the single-core fibers (GRIN-SCFⱼ).

These couplings may be performed by removable mechanical assembly, by bonding, or any other suitable assembly.

The diameter of the gradient-index fiber section is d_{GRIN-L}. This diameter d_{GRIN-L} may be between 125 μm and 4 mm, typically equal to 1 mm.

The alignment of the lens with the other elements of the system is limited by any defects present on the edges of the lens. More specifically, the gradient-index lens has a central axis O_{GRIN-L}. According to an embodiment, this axis O_{GRIN-L} is aligned with the main axis of the system O₀, with a tolerance of 3 μm, or with a tolerance of 1 μm. Thus, according to a particular example embodiment illustrated by FIG. 7, this central axis O_{GRIN-L} is merged with the main axis of the system O₀.

The gradient-index lens (GRIN-L) may be composed of organic or mineral glass. The material used may be doped to obtain a specific refractive index profile. According to an example embodiment, this profile declines from the center of the lens toward its circumference. Thus, the refractive index at the center of the gradient-index lens is n₂. According to an example embodiment wherein the lens is made of pure silica, this index n₂ is greater than the refractive index of the silica nₛᵢ, where nₛᵢ=1.457 to 632.8 nm (for an HeNe laser). In this case, the refractive index profile may be obtained by doping silica with one or more elements making it possible to increase or decrease the refractive index of silica (Ge, P, Al, Cl, Ti, Br, B, F).

The quadratic coefficient of the gradient-index section is g₂. This quadratic coefficient g₂ has values typically between 0.5 and 10 mm⁻¹.

The length of the gradient-index fiber section (GRIN-L) is l₂. This length l₂ is between 500 μm and 10 mm, typically of the order of one millimeter. This length l₂ is defined according to the quadratic coefficient of the lens g₂. More particularly, this length is defined by the formula:

$${l}_{2} = \frac{π}{2 \times {g}_{2}}$$

Thus, this gradient-index lens has a lensing and collimation function in order to control the radius and angle of the optical beam transmitted. All of the parameters mentioned above are co-dependent and may be adapted to obtain the desired dimensions and orientations, and thus optimize the transmission of the optical beam.

### 2. Coupling Method

The coupling method according to the disclosed technology may use different types of assemblies such as welding, removable mechanical assembly, bonding mechanical assembly, etc.

More particularly, the method comprises welding of the gradient-index sections (GRIN-MCF, GRIN-SCF) to the corresponding multi-core (MCF) and single-core fibers (SCF). Thus, as illustrated by FIG. 8, the coupling method according to the disclosed technology comprises:
a step of welding (S-MCF) a first gradient-index fiber section at the end of said multi-core fiber to form a first microlensed end;
for each single-core fiber (SCF) of said set, a step of welding (S-SCF) a second gradient-index fiber section (GRIN-SCF) at the end of the multi-core fiber to form a second microlensed end;

The gradient-index fiber sections having preferably a similar diameter to that of the corresponding optical fibers, welding is thus facilitated, and this makes it possible to create correctly aligned microlensed ends definitively attached to the multi-core and single-core optical fibers.

Furthermore, each of the microlensed ends thus formed may be mechanically assembled with the gradient-index lens (GRIN-L), for example by bonding, via a removable mechanical connection such as ferrules, etc. More particularly, as illustrated by FIG. 8, the coupling method according to the disclosed technology also comprises:
a step of mechanically assembling (AS-MCF/L) said first microlensed end of the multi-core fiber with a first interface of a gradient-index lens;
a step of mechanically assembling (AS-SCF/L) the second microlensed end of the single-core fiber with a second interface of said gradient-index lens.

Thus, such a coupling method allows a simple assembly where the alignment of the different elements is facilitated. In particular, the use of gradient-index fiber sections having a similar diameter to the diameter of the multi/single-core fibers allows definitive attachment by welding. The system thus obtained and compact and easy to implement.

It is understood that the elements described relative to the system may be applied to the method and conversely. More particularly, the radial offset of a single-core fiber (and of the corresponding microlensed end) relative to the multi-core fiber (and to the corresponding microlensed end) is dependent on a core parameter of the multi-core fiber. More specifically, the optical axis of the assembled single-core fiber advantageously has an offset of a distance h with the main optical axis of the system, the distance h being defined according to the distance e between the main optical axis of the system and the optical axis of the core of the multi-core optical fiber, the beam of which is transmitted to the assembled single-core optical fiber. This distance h is greater than a threshold value according to the diameter of the single-core fibers, typically a minimum threshold value facilitating the coupling of the single-core fibers on the lens GRIN-L.

### 3. Example Embodiments

### 3.1. Example 1

A first particular example of a coupling system according to the disclosed technology is represented by FIG. 9, FIG. 10, FIG. 11 and FIG. 12. According to this first example, the multi-core optical fiber has four cores (C_{MCF-1}, C_{MCF-2}, C_{MCF-3}, C_{MCF-4}), and the system comprises four single-core fibers (SCF₁, SCF₂, SCF₃, SCF₄), the transmission of the optical signal being performed from the multi-core fiber to the single-core fibers.

According to this example, the optical beam from the core C_{MCF-1} is intended to be transmitted to the single-core fiber SCF₁, the beam from the core C_{MCF-2} is intended to be transmitted to the fiber SCF₂, the beam from the core C_{MCF-3} is intended to be transmitted to the fiber SCF₃, the beam from the core C_{MCF-4} is intended to be transmitted to the fiber SCF₄,

Furthermore, the center of each of these cores is spaced by a distance eᵢ (e₁, e₄) relative to the main axis of the system (O₀). More specifically, FIG. 9 represents, on one hand, a cross-section (A-A) of a multi-core optical fiber, with a uniform distribution of the four cores about the main optical axis of the system (O₀); and, on the other, FIG. 9 represents a longitudinal section (B-B) of this optical fiber, passing through the main optical axis of the system, at the cores C_{MCF-1}, and C_{MCF-4}. The plane of this longitudinal section B-B therefore comprises the axes O₀, O_{MCF-1} and O_{MCF-4}.

In this example, the wavelength A selected is equal to 380 μm. The diameter of all of the optical fibers and gradient-index fiber sections is equal to 125 μm. Furthermore, each gradient-index section is perfectly aligned with the optical fiber with which it is coupled.

With respect to the multi-core fiber (MCF), the center of each of its cores is at a distance e=10 μm from the center of the multi-core fiber (corresponding to the main optical axis of the system O₀). Furthermore, the diameter of the optical beam ω₀ is equal to 5 μm at the output of the multi-core fiber.

With respect to the gradient-index fiber section of the multi-core fiber (GRIN-MCF), as illustrated by FIG. 10 and FIG. 12, the refractive index at the center of the section n₁ is equal to 1.472. The quadratic coefficient g₁ of the section is equal to 4.3 mm⁻¹. The length l₁ of the section is therefore determined as follows:

$${l}_{1} = \frac{π}{2 \times {g}_{1}} = 365 μ m .$$

Furthermore, the diameter of the beams ω₁ at the output of the gradient-index fiber section is determined as follows:

$${ω}_{1} = \frac{λ}{π \times {n}_{1} \times {g}_{1} \times {ω}_{0}} = 3.8 mm .$$

And finally, as indicated by FIG. 10, the angles θ₁ and θ₄ of the beams from the cores C_{MCF-1} and C_{MCF-4}, at the output of the section, measured relative to the main optical axis of the system O₀, are equal to θᵢ=e×g₁=0.043 rad.

With respect to the gradient-index lens (GRIN-L), as illustrated by FIG. 12, the diameter of the lens d₂ is approximately 1 mm. The refractive index n₂ at the center of the lens is equal to n₁. The quadratic coefficient g₂ of the lens is equal to 0.6 mm⁻¹. The length l₁ of the lens is therefore determined as follows:

$${l}_{2} = \frac{π}{2 \times {g}_{2}} = 2618 μ m .$$

Furthermore, the diameter of the beams ω₁ at the output of the gradient-index fiber section is determined as follows:

$${ω}_{2} = \frac{λ}{π \times {n}_{2} \times {g}_{2} \times {ω}_{1}} = {ω}_{0} \times \frac{{n}_{1} \times {g}_{1}}{{n}_{2} \times {g}_{2}} = 35.8 μ m .$$

Finally, the angle of the optical beam relative to the main optical axis at the output of the lens is zero.

With respect to the gradient-index fiber sections of the single-core fibers (GRIN-SCF₁, GRIN-SCF₂, GRIN-SCF₃, GRIN-SCF₄), as illustrated by FIG. 12, the refractive index at the center of the section ng is equal to 1.6. The diameter ω₃ of the optical beam at the section output (and at the input of the single-core fiber) is equal to ω₃=ω₀=5 μm. Finally, the distance between the optical axis of the system and the center of each of the single-core fibers is equal to

$$h = e \times \frac{{n}_{1} \times {g}_{1}}{{n}_{2} \times {g}_{2}} = 71 μ m .$$

With respect to the single-core optical fibers (SCF₁, SCF₂, SCF₃, SCF₄), they are centered on the gradient-index fiber sections with which they are coupled, and are therefore also offset by a distance h=71 μm relative to the main axis of the system O₀.

In the case of a multi-core optical fiber according to this first example, the optical parameters are selected so that the distance h complies with the following inequality:

$$h > \frac{{d}_{SCF - j}}{2} .$$

In this case: h>62.5 μm.

Finally, in the case of this first example, the gradient-index fiber sections and the gradient-index lens used have specific refractive index profiles. Thus, FIG. 11 illustrates the progression of the refractive index as a function of the distance to the center of each of these elements. More specifically, considering R1=d_{GRIN-MCF}/2, the refractive index of the gradient-index fiber section of the multi-core fiber has a maximum value at its center equal to n₁, followed by a value decreasing to nₛᵢ for a distance to the center of R1 or −R1. Considering R2=d_{GRIN-L}/2, the refractive index of the gradient-index lens has a maximum value at its center equal to n₂, followed by a value decreasing to nₛᵢ for a distance to the center of R2 or −R2. Finally, considering R3=d_{GRIN-SCF}/2, the refractive index of the gradient-index fiber section of a single-core fiber has a maximum value at its center equal to n₃, followed by a value decreasing to nₛᵢ for a distance to the center of R3 or −R3.

### 3.2. Example 2

A second particular example of a coupling system according to the disclosed technology is represented by FIG. 13, FIG. 14, and FIG. 15.

According to this example, a multi-core optical fiber may have a central core (C_{MCF-5}), and peripheral cores (C_{MCF-1}, C_{MCF-2}, C_{MCF-3}, C_{MCF-4}).

By applying the technique described above, the beam from the central core of the multi-core fiber is not deflected, to be transmitted to a single-core optical fiber. Indeed, because e₅=0, then: θ₅=e×g₁=0 and h=0.

Therefore, there is no offset of the single-core optical fiber to which the beam from the central core of the multi-core fiber is transmitted. The single-core optical fiber SCF₅ is centered on the same main axis as the multi-core optical fiber.

More specifically, FIG. 13 represents, on one hand, a cross-section (A-A) of a multi-core optical fiber, with a uniform distribution of four cores about the main optical axis of the system (O₀) and a central core; and, on the other, FIG. 13 represents a longitudinal section (B-B) of this optical fiber, passing through the main optical axis of the system, at the cores C_{MCF-1}, C_{MCF-4} and C_{MCF-5}. The plane of this longitudinal section B-B therefore comprises the axes O₀, O_{MCF-1}, O_{MCF-4} and O_{MCF-5}, with the axes O₀ and O_{MCF-5} merged.

### 4. Additions

### 4.1. Additional Optical Functions

Additional optical functions may be added to the system, they may be implemented by adding at least one of the following optical components:
an optical strip;
an optical filter;
an anti-glare component;
an optical isolator.

These components may be disposed between two elements of the coupling system, in particular, between the gradient-index lens and one of the gradient-index fiber sections of the multi-core fiber and/or a single-core fiber.

According to an embodiment illustrated by FIG. 16, an additional component having a specific optical function is added between the gradient-index lens and the gradient-index fiber sections associated with single-core fibers. More particularly, each of the sections illustrated (GRIN-SCF₁, GRIN-SCF₄) is separated from the lens (GRIN-L) by a separate optical component (11, 14). However, these additional components may also be identical for all of the gradient-index fiber sections, or may be added only at the end of some of these.

Thus, according to a particular embodiment, at least one of the gradient-index fiber sections of the multi-core fiber or a single-core fibers is coupled at the input and/or at the output of said gradient-index lens via an additional optical component.

Moreover, in order to add such an additional element, it is possible to adjust the choice of parameters of the gradient index, the external diameter and the length of the gradient-index fiber sections.

These additional components may be fitted in the system according to different methods, for example the so-called “V-groove” method, or a method using fibers mounted in cylindrical ferrules with an alignment sleeve. The “V-groove” method uses V-shaped grooves wherein the elements to be aligned and assembled are placed, the groove making it possible to facilitate alignment; whereas the “sleeve” method uses a sleeve wherein ferrules are inserted in order to align the fibers (or other elements) present in these ferrules. These methods may also be used for the alignment of the other elements of the coupling system.

Furthermore, adding such additional optical components makes it possible to obtain a more elaborate and complete system with additional optical functions, the system remaining compact and easy to implement.

4.2. Implementation with Ferrule-Type Connectors

The coupling system according to the disclosed technology may be implemented via the use of specific connectors such as ferrules, making it possible to form blocks of elements to be interconnected.

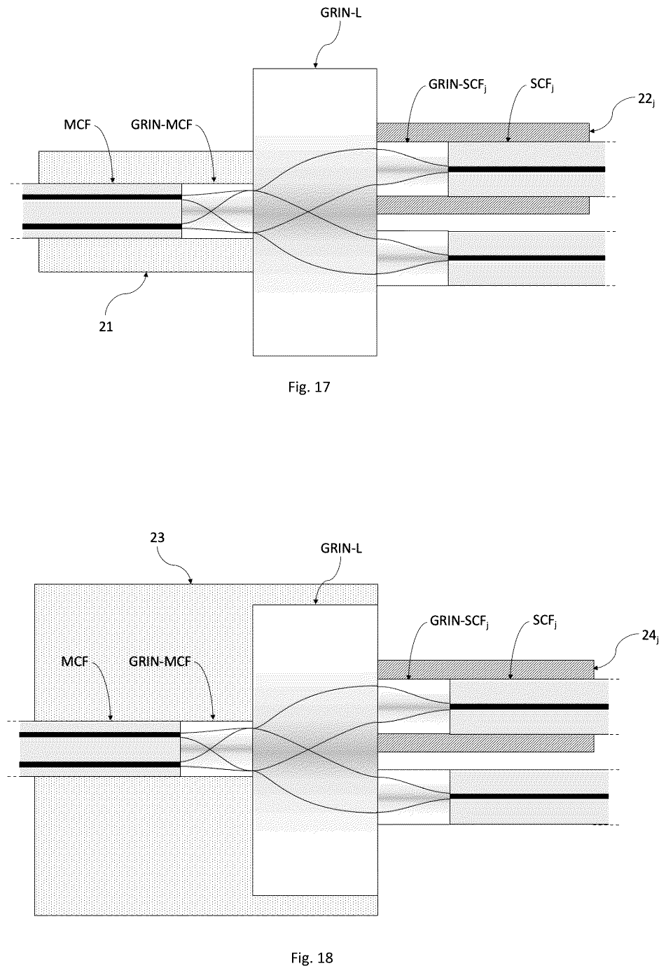

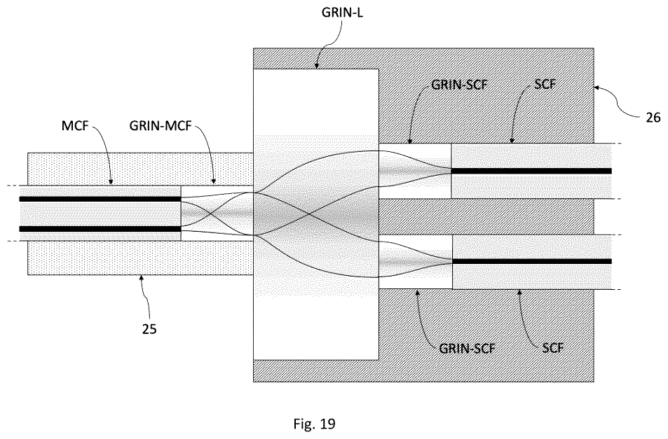

FIG. 17, FIG. 18 and FIG. 19 illustrate three different configurations that can be implemented to allow the interconnection of different element blocks of the system.

Thus, according to a first example, FIG. 17 illustrates a first configuration wherein:
the end of the multi-core fiber (MCF) and the corresponding gradient-index fiber section (GRIN-MCF) are comprised in an independent ferrule (21);
each end of the single-core fiber (SCFⱼ) and the corresponding gradient-index fiber section (GRIN-SCFⱼ) are comprised in an independent ferrule (22ⱼ); and
the gradient-index lens (GRIN-L) is independent.

According to a second example, FIG. 18 illustrates a second configuration wherein:
the end of the multi-core fiber (MCF), the corresponding gradient-index fiber section (GRIN-MCF) and the gradient-index lens (GRIN-L) are comprised in an independent ferrule (23), on one hand;
each end of the single-core fiber (SCFⱼ) and the corresponding gradient-index fiber section (GRIN-SCFⱼ) are comprised in an independent ferrule (24ⱼ), on the other.

Finally, FIG. 19 illustrates a third configuration wherein:
the end of the multi-core fiber (MCF) and the corresponding gradient-index fiber section (GRIN-MCF) are comprised in a first independent ferrule (25) on one hand;
the end of the single-core fibers (SCFⱼ), each corresponding gradient-index fiber section (GRIN-SCFⱼ), and the gradient-index lens (GRIN-L) are comprised in a second ferrule (26), on the other.

Thus, the use of such connectors makes it possible to facilitate the implementation of the coupling system, by facilitating the alignment of the elements and their interconnection.

What is claimed is:

1. A coupling system between a multi-core optical fiber and a set of at least one single-core optical fiber, wherein each single-core fiber of said set is coupled with a separate core of the multi-core fiber comprising an end, said coupling system comprising:
a gradient-index lens, positioned between said multi-core fiber and said at least one single-core fiber;
a first gradient-index fiber section coupled at the end of the multi-core fiber to form a first microlensed end; and
for at least one single-core fiber of said set, a second gradient-index fiber section coupled at the end of the multi-core fiber to form a second microlensed end, wherein said first and second microlensed ends are coupled on either side of said lens with a radial offset of one relative to the other defined according to a core parameter of the multi-core fiber.

2. The coupling system according to claim 1, wherein the radial offset of a single-core fiber is defined by a distance h, the distance h being defined as follows:
$$h = e \times \frac{{n}_{1} \times {g}_{1}}{{n}_{2} \times {g}_{2}}$$
wherein:
e is a core parameter, defined as being the radial distance between a central axis of the multi-core fiber and an axis of the core of the multi-core fiber with which said single-core fiber is coupled;
n₁ is a refractive index at the center of said first gradient-index fiber section;
g₁ is a quadratic coefficient of said first gradient-index fiber section;
n₂ is a refractive index at the center of said gradient-index lens; and
g₂ is a quadratic coefficient of said gradient-index lens.

3. The coupling system according to claim 1, wherein:
a length l₁ of the first gradient-index fiber section of said multi-core fiber is inversely proportional to its quadratic coefficient g₁;
a length l₂ of the gradient-index lens is inversely proportional to its quadratic coefficient g₂; and
a length l₃ of the gradient-index fiber section of the at least one single-core fiber is inversely proportional to its quadratic coefficient g₃.

4. The coupling system according to claim 1, wherein the cores of the multi-core optical fiber and the set of at least one single-core optical fiber are of single-mode type.

5. The coupling system according to claim 1, wherein said first and second microlensed ends are coupled directly at an input and output of said gradient-index lens.

6. The coupling system according to claim 5, wherein at least one of said first and second microlensed ends is coupled at the input and output of said gradient-index lens via an optical component belonging to the group comprising:
an optical strip;
an optical filter;
an anti-glare component; and
an optical isolator.

7. The coupling system according to claim 1, wherein:
the end of the multi-core fiber and the first microlensed end are comprised in an independent ferrule;
each end of the single-core fiber and the second microlensed end are comprised in an independent ferrule; and
the gradient-index lens is independent.

8. The coupling system according to claim 1, wherein:
the end of the multi-core fiber, the first microlensed end, and the gradient-index lens are comprised in a same ferrule, on one hand; and
each end of the single-core fiber and the second microlensed end are comprised in an independent ferrule, on the other.

9. The coupling system according to claim 1, wherein:
the end of the multi-core fiber and the first microlensed end are comprised in a first independent ferrule, on one hand; and
the set of at least one single-core fiber end, each second microlensed end and the gradient-index lens are comprised in a second ferrule, on the other.

10. A method for coupling a multi-code optical fiber and a set of at least one single-core optical fiber, wherein the method comprises:
welding a first gradient-index fiber section at an end of a multi-core fiber to form a first microlensed end;
for at least one single-core fiber of said set, welding a second gradient-index fiber section at the end of the multi-core fiber to form a second microlensed end;
mechanically assembling said first microlensed end of said multi-core fiber with a first interface of a gradient-index lens; and
mechanically assembling said second microlensed end of said single-core fiber with a second interface of said gradient-index lens, with a radial offset relative to the first microlensed end, defined according to a core parameter of the multi-core fiber.
